(19) United States
(12) Patent Application Publication
(10) Pub. No.: US 2025/0333363 A1
(43) Pub. Date: Oct. 30, 2025

(54) Composition and Method for Improving Xeric Plant Health

(71) Applicant: Andrew Carder Nastcj, Austin, TX (US)

(72) Inventor: Andrew Carder Nastcj, Austin, TX (US)

(21) Appl. No.: 18/648,418

(22) Filed: Apr. 28, 2024

(51) Int. Cl. C05G 5/12; C05D 9/00

(52) U.S. Cl. CPC C05G 5/12; C05D 3/02; C05D 9/00

(57) ABSTRACT

The present invention is a soil amendment and soil top dressing used in potted and landscape xeric plants, also known as succulents and cacti. This soil amendment is made of a composition of different rock aggregates of specific sizes that improves plant health by providing the specific spectrum of mineral nutrients needed by xeric plants. The present invention includes a method to replicate the soil texture and composition of natural environments where xeric plants originate. This soil amendment is used in landscaping and horticultural operations (at home or commercially) to increase mineral absorption, soil drainage, and provide stability to newly planted specimens.

### 2. CROSS-REFERENCE TO RELATED APPLICATIONS

Not Applicable

### 3. STATEMENT REGARDING FEDERALLY SPONSORED RESEARCH OR DEVELOPMENT

Not Applicable

### 4. REFERENCE TO A SEQUENCE LISTING, LARGE TABLE, or a COMPUTER PROGRAM LISTING APPENDIX ON READ-ONLY OPTICAL

Not Applicable

### 5. BACKGROUND OF THE INVENTION

This invention relates to the field of landscaping, horticulture, and ornamental plants. More particularly, this invention relates to the field of soil amendments and top dressings to increase the health and longevity of cacti and succulents, here referred to as xeric plants. The present invention further relates to the field of potting and staging xeric bonsai, defined as xeric plants staged in an artistic way. The present invention is designed for, but not limited to xeric plants, some families and genus include Ariocarpus, Astrophytum, Aizoaceae, Copiapoa, Ferocactus, Dudleyas, Echeverias, Crassula, Sedum, Bursera, Tylecodon, among others.

### 6. BRIEF SUMMARY OF THE INVENTION

The present invention is a composition for enhancing the growth of xeric plants. The invention consists of 100% rock aggregates. The rock aggregates in the present invention are defined as any naturally occurring mineral compounds that are mined from deposits of igneous, sedimentary, and metamorphic rocks in the earth's crust. The rock aggregates are in a specific range of sizes: 0.001 millimeters to 10 millimeters. The rock aggregates can be composed of a combination of minerals such as feldspar, pyroxene, calcite, dolomite, among others. To create the invention, these rock aggregates are then further refined down to specific diameter sizes. The rock aggregates are then separated by diameter size and combined in a formulated blend.

### 7. BRIEF DESCRIPTION OF SEVERAL VIEWS OF THE DRAWING

FIG. 1—shows the range of particle sizes used in the present invention from 0.001 mm to 10 mm, in order to achieve the desired soil texture.

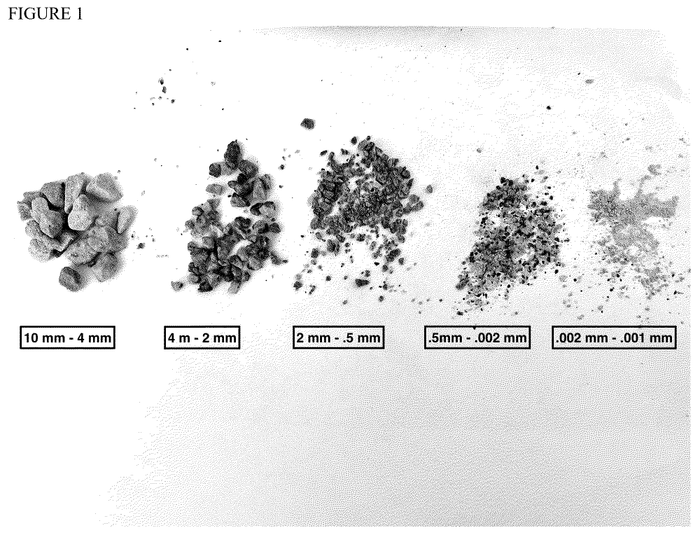

FIG. 2—shows 2 Copiapoa Columna Alba seedlings. The Seeds for these plants came from the same seed pot, share the same genetics, and were planted at the same time. Specimen 1 was grown without the invention. Specimen 2 was grown with the invention. As evidenced by the larger size, specimen 2 had a much faster growth rate. Larger spines on specimen 2 are also evident and caused by the minerals available in the invention.

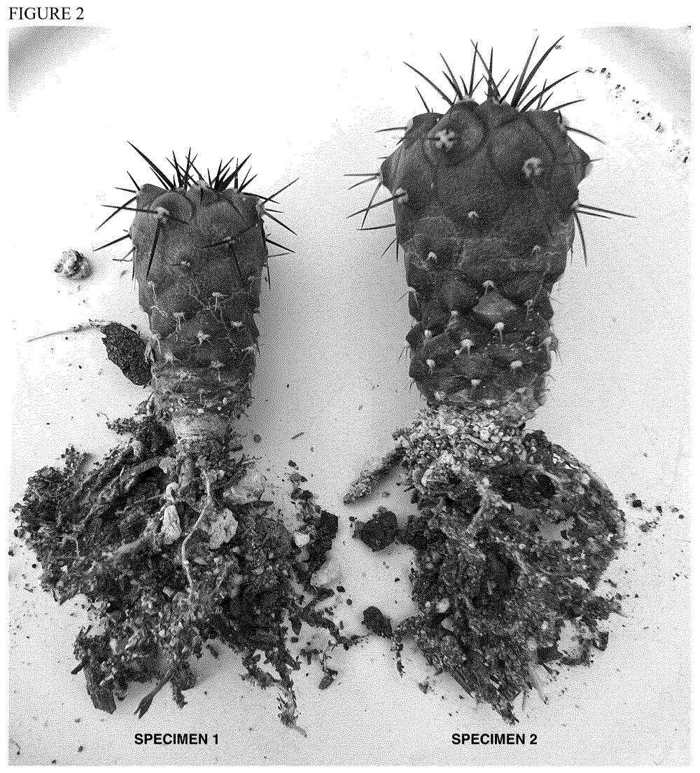

### 8. DETAILED DESCRIPTION OF THE INVENTION

There are various embodiments of the current invention, but all are made up of a combination of 4-5 of the following rock aggregates. Each rock aggregate's positive effect on xeric plant health is also included:
Limestone-raises PH and available calcium for spine formation in cacti;
Decomposed Granite (all colors)-provides drainage, stabilizes soil texture and soil PH;
Andesite-Helps balance PH and brix (sugar content) and nutrient levels in plants. Encourages earthworm and beneficial microbial activity;
Red Marble-raises PH and available calcium;
Basalt-increases minerals available to plants such as magnesium and potassium;
Lava rock (scoria)-increases drainage and allows oxygen to reach plant roots;
Coarse silica sand-provides soil stability and stabilizes PH level;
Quartz-provides PH stability and stability to plant roots.

The present invention uses formulated blends to mimic the geology and soil texture of major deserts worldwide, including the Chihuahua, Atacama, and Karoo Deserts. Soil texture is defined as the proportion of sand, silt, and clay sized particles that make up the unique mineral aspect of a given substrate or soil. Succulents and cacti require specific soil texture to avoid root rot. The current invention creates a soil texture that allows oxygen to flow through the roots, cutting down on anaerobic conditions that favor harmful bacteria and fungi. The soil texture created by the invention also provides less resistance and more growing space for new roots. Furthermore, this invention greatly increases the longevity of sensitive xeric plants, by creating a high concentration gradient of minerals in the soil, making it easier for plants to passively uptake minerals. When used as a top dressing in potted plants, the present invention also provides an aesthetically pleasing natural look. It transforms potted plants into a stunning slice of the desert.

The present invention has 3 current embodiments known as “Karoo”, “Atacama”, and “Chihuahua”. These embodiments provide the range of mineral nutrients needed by plants native to the particular desert each embodiment is named after.
For the Karoo embodiment mix, 1 part quartz, 1 part marble, 1 part decomposed granite, ½ parts silica sand, ¼ parts limestone, are mixed together.
For the Atacama embodiment mix, ½ parts scoria, 1½ parts decomposed granite, 1/16 parts andesite, ½ parts silica sand, 1 part basalt are mixed together.
For the Chihuahua embodiment mix, 1 part limestone, 1 part decomposed granite, 1/16 part chert, ½ silica sand are mixed together.

To create the invention, the previously listed rock aggregate ingredients are sorted by particle diameter. A formulate percentage of each particle size (ranging from 0.001 mm to 10 mm) are mixed together to achieve the ideal soil texture for succulents and cacti. The formulated blend of particle sizes contained in the given invention are important because if there are too many small particles, namely clay and silt, oxygen can't reach the roots of xeric plants. Too many big particles, namely sand and pebbles, will cause roots to dry out and the plant will be unable to absorb minerals. The current invention uses
5-15% rock aggregate particles 0.002-0.0001 mm in diameter;
10-25% rock aggregate particles 0.5-0.002 mm in diameter;
10-25% rock aggregate Particles 2 mm-0.5 mm in diameter;
and 10-25% rock aggregate particles 10-4 mm in diameter.

This combination of particle sizes causes the invention to lock into place once settled in the soil and stabilize newly planted succulents and cacti, by anchoring their roots in a stiff matrix. This locking into place feature of the invention is caused by the flocculating cations of the clay sized particles. Clay particles are defined as particles smaller than. 002 mm. The 5-15% amount of clay particles used in the invention creates a soil texture that is able to stabilize and lock the plant in place, but allows the soil to still be dispersed enough for root growth.

To use the present invention, scoop or shovel the invention into organic materials like peat, compost, or general plant soil and mix thoroughly. This improves drainage and mineral absorption while reducing root rot and other pathogens. If mixed into the soil a ratio of 50% of this invention to 50% soil should be used.

Users can also use the present invention as a decorative top dressing. To use as a top dressing, Sprinkle a 1-2 inch layer onto the top of the soil in a pot or in the landscape. Then gently press on the invention with hands or garden tools. The topping creates a natural look in landscapes and planters. When used as a top dressing, the minerals are still able to reach plant roots when watered. The picturesque top dressing transforms pots and beds into stunning desert scenes, identical to the real world ecosystems. After being wetted down with a soft shower of water or tamped with a tool or by hand, the invention will settle, creating ideal soil texture and securing the plant in place.

By growing xeric plants in the invention, a cactus' dermis is brighter and spines are thicker. Succulents like lithops gain a great range of color and roots that reach deep into the soil mixture created by the invention. These listed attributes are seen in wild plants, but are often lost in the greenhouse and human care. Standard horticultural practices can cause dull green dermis and thin spines on cacti. While lithops become overly plump and split open when the current invention is not used. The mineral content and soil texture of this invention causes xeric plants to look and behave more like their wild counterparts, thus cutting down the need for poachers to rip wild plants out of nature.

What is claimed:

1. A soil amendment and top dressing composition that comprises
A. Limestone;
B. Decomposed granite;
C. Andesite;
D. Marble;
E. Basalt;
F. Scoria;
G. Quartz;
H. Chert;
I. Silica sand
or some combination thereof.

2. A soil amendment as in claim 1 that comprises
A. rock aggregate particles 0.002-0.001 mm in diameter;
B. rock aggregate particles 0.5-0.002 mm in diameter;
C. rock aggregate Particles 2-0.5 mm in diameter;
D. rock aggregate Particles 4-2 mm in diameter;
E. rock aggregate Particles 10-4 mm in diameter
or some combination thereof.

3. A soil amendment as in claim 1 wherein the composition of the invention is used on a xeric plant in
A. The Aizoaceae family,
B. Cactaceae family,
C. Crassulaceae family,
D. Apocynaceae family,
E. Asparagaceae family, among others.

4. A soil amendment as in claim 2 wherein the differing particle sizes of rock aggregates lock into place within the soil because of flocculating cations and stabilize newly planted xeric plants.

5. a method for replicating naturally occurring desert soil textures in potted plants by mixing rock aggregates of incremental diameter sizes between 0.001 mm to 10 mm.
